(19) United States
(12) Patent Application Publication
(10) Pub. No.: US 2011/0035365 A1
(43) Pub. Date: Feb. 10, 2011

(54) Distributed Knowledge Storage

(75) Inventor: Robert A. Butler, IV, Lewisville, TX (US)

Correspondence Address: BAKER BOTTS LLP, 2001 ROSS AVENUE, 6TH FLOOR, DALLAS, TX, 75201-2980, US

(73) Assignee: Raytheon Company, Watham, MA (US)

(21) Appl. No.: 12/537,110

(22) Filed: Aug. 6, 2009

(51) Int. Cl. G06F 17/30; G06N 5/02

(52) U.S. Cl. 707/704; 707/E17.044; 707/E17.014; 707/E17.032; 707/E17.112

(57) ABSTRACT

According to one embodiment, a method for writing to a distributed knowledge store includes receiving a plurality of Resource Description Framework (RDF) expressions. A distributed knowledge store is identified. The distributed knowledge store contains a plurality of physical knowledge stores. The RDF expressions are written to the distributed knowledge store by storing the plurality of RDF expressions in a buffer and then receiving a plurality of threads from the plurality of physical knowledge stores. The plurality of threads are responsible for downloading the plurality of RDF expressions to the plurality of physical knowledge stores.

### TECHNICAL FIELD

This invention relates generally to the field of computer programming and more specifically to distributed knowledge storage.

### BACKGROUND

Data storage systems may be used to record information, process information, or both. A data storage system's capacity measures the total amount of information that a data storage system may hold. If a data storage system exhausts its available storage capacity, additional storage capacity may be necessary.

### SUMMARY OF THE DISCLOSURE

According to one embodiment, a method for writing to a distributed knowledge store includes receiving a plurality of Resource Description Framework (RDF) expressions. A distributed knowledge store is identified. The distributed knowledge store contains a plurality of physical knowledge stores. The RDF expressions are written to the distributed knowledge store by storing the plurality of RDF expressions in a buffer and then receiving a plurality of threads from the plurality of physical knowledge stores. The plurality of threads are responsible for downloading the plurality of RDF expressions to the plurality of physical knowledge stores.

Certain embodiments of the invention may provide one or more technical advantages. A technical advantage of one embodiment may be the capability to provide a distributed knowledge store that include multiple physical knowledge stores that span multiple domains or enterprises. Yet other technical advantages may include the capability to manage multiple physical knowledge stores through a single access point and represent the distributed knowledge stores as a single knowledge store. Yet other technical advantages may include the capability to enable multiple clients to read from and write to multiple physical knowledge stores.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 presents one embodiment of distributed knowledge storage system;

FIG. 2 presents one embodiment of writing to a distributed knowledge storage system;

FIG. 3 presents one embodiment of a method for reading or querying from a distributed knowledge storage system;

FIG. 4 presents one example of a query execution mechanism that may be incorporated into the method presented in FIG. 3;

FIG. 5 presents one embodiment of a method for connecting multiple clients to a remote knowledge store;

FIG. 6 presents one embodiment of a knowledge storage system that may execute the method presented in FIG. 5; and

FIG. 7 presents an embodiment of a general purpose computer operable to perform one or more operations of various embodiments of the invention.

### DETAILED DESCRIPTION OF THE DRAWINGS

It should be understood at the outset that, although example implementations of embodiments of the invention are presented below, the present invention may be implemented using any number of techniques, whether currently known or not. The present invention should in no way be limited to the example implementations, drawings, and techniques presented below. Additionally, the drawings are not necessarily drawn to scale.

Application Programming Interfaces (APIs) may be used to extract data from and write data to a knowledge store. For example, Jena is a Semantic Web framework for Java that provides an API to extra data from and write data to Resource Description Framework (RDF) graphs. Other examples of an RDF framework may include Sesame and AllegroGraph.

However, existing frameworks may not support distributed knowledge stores. Accordingly, teachings of certain embodiments recognize the use of a distributed knowledge store system that include multiple physical knowledge stores that span multiple domains or enterprises. In some embodiments, the distributed knowledge store system may be used as an extension of a framework such as Jena. In other embodiments, the distributed knowledge store system may represent an independent framework.

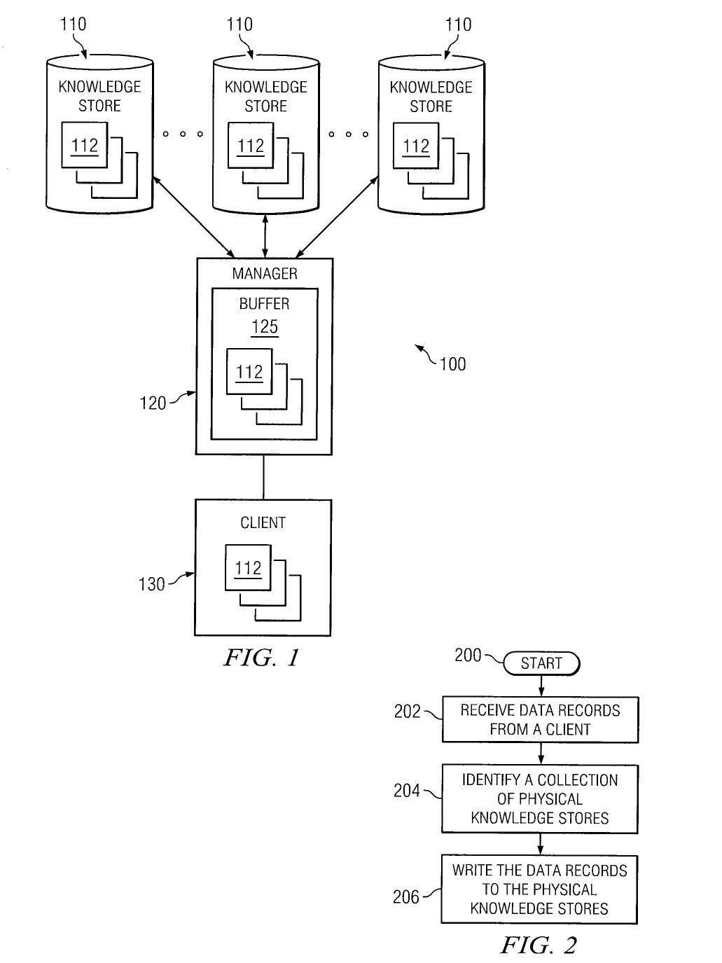

FIG. 1 presents one embodiment of distributed knowledge storage system 100. The components of the distributed knowledge storage system 100 of FIG. 1 may include a plurality of knowledge stores 110, a manager 120, a buffer 125, and a client 130.

The knowledge store 110 may include any physical knowledge stores capable of storing a structured collection of data records 112. The data records 112 may represent a conceptual description or modeling of information. Embodiments of the data records 112 may be defined according to a semantic data model. A semantic data model is a data-modeling technique to define the meaning of data within the context of its interrelationships with other data.

In some embodiments, the data records 112 may be defined as a RDF expression. An example of an RDF expression is an RDF triple, which describes data in the form of a subject-predicate-object expression. The subject denotes the resource. The predicate denotes traits or aspects of the resource and expresses a relationship between the subject and the object. For example, the notion “the sky has the color blue” may be expressed as an RDF triple: a subject denoting “the sky,” a predicate denoting “has the color,” and an object denoting “blue.”

A collection of RDF statements may resemble a labeled graph under graph theory. A graph is an abstraction of relationships among objects. A graph includes two or more nodes and one or more edges connecting the nodes. Graph labeling refers to the assignment of unique labels to the edges and nodes of a graph. A subgraph is a graph whose node set is a subset of another graph.

Collections of the data records 112 may be accessed using a query executed using a query language. In several embodiments, queries may be executed to retrieve the data records 112 according to an RDF query language such as SPARQL Protocol and RDF Query Language (“SPARQL”). Other examples of a query language may include RDF query language (RDQL), Versa, and XML User Interface Language (XUL).

A query of RDF expressions may contain a set of triple patterns. A triple pattern resembles an RDF triple. However, the subject, predicate, and object of a triple pattern may be a variable. In a query, the triple pattern matches the RDF expression when the terms of the RDF triple may be substituted for the variables of the triple pattern. In some embodiments, queries may also include groups of triple patterns, and some of the triple patterns may include variables that relate to one another. In some embodiments, queries may also include complex filters, aggregation statements, sorting statements optional patterns, and such.

The manager 120 may manage interactions between the knowledge stores 110 and the client 130. The manager may include a buffer 125. The buffer 125 may operate as a temporary cache for transfers between the knowledge stores 110 and the client 130. For example, the buffer 125 may accumulate data records 112 and then transmit the data records 112 as a large batch. In some embodiments, the client 130 may also include the capacity to store a cache of a collection of data records 112.

FIG. 2 presents one embodiment of writing to a distributed knowledge storage system. The method of FIG. 2 may incorporate one or more components of the distributed knowledge storage system of FIG. 1.

The method of FIG. 2 starts at step 200. At step 202, data records are received from a client. One example of the data records of step 202 may be the data records 112 from FIG. 1. One example of the client of step 202 may be the client 130 from FIG. 1.

At step 204, a collection of physical knowledge stores is identified. One example of the physical knowledge stores of step 204 may be the knowledge stores 110 from FIG. 1. The physical knowledge stores may be organized into a distributed knowledge store. In one embodiment, the distributed knowledge store may be represented as a graph, and the physical knowledge stores may be represented as subgraphs of the graph.

At step 206, the data records are written to the physical knowledge stores. In some embodiments, step 206 may include executing a series of steps for assigning the data records to the physical knowledge stores. For example, in some embodiments, the step 206 may be performed by storing the data records in a buffer. One example of the buffer of step 206 may include the buffer 125 of FIG. 1.

In one embodiment, the buffer may receive some number of input data records from a client. The buffer may allow clients to “write” data records to the buffer up to the buffer size, thus grouping individual data records into potentially larger groups of data records. Teachings of certain embodiments recognize that grouping individual data records into larger groups of data records may increase efficiency of downloading data records to the physical knowledge stores.

Theoretically, the highest write potential for the distributed knowledge store would be the total of the write potentials for each individual physical knowledge store. However, fair distribution mechanisms, such as round-robin or random assignment, may only produce a write potential equal to the average of the write potentials of the individual physical knowledge stores. Accordingly, teachings of certain embodiments recognize the use of threads to write to individual physical knowledge stores.

In one embodiment, the individual physical data stores include a thread that is responsible for downloading groups of data records to the individual physical data stores. For example, the thread may be responsible for downloading the groups of data records from the buffer to the individual physical data stores. Teachings of certain embodiments recognize that download threads may balance data record distribution. For example, some physical data stores may have higher write potentials, and the threads associated with those physical data stores may be able to process and download data records more quickly, resulting in more data records downloaded from the buffer. Thus, in some embodiments, the buffer size may represent the total of the write potentials for each individual physical knowledge store.

In some embodiments, the buffer may store data records until a minimum number of data records have been accumulated. After this minimum number of data records has been accumulated, the threads may begin downloading the data records to the physical knowledge stores. In one embodiment, the minimum number of data records may be set at the maximum capacity of the buffer, such that the threads will not begin downloading the data records until the buffer is full. In another embodiment, the size of the buffer may represent the total write potential for the distributed knowledge store, setting a maximum number of data records that may be stored in the buffer.

In some embodiments, one thread may be assigned to one physical data store, resulting in a one-to-one correlation between threads and physical data stores. However, in other embodiments, two threads may be assigned to a physical data store, or two physical data stores may share one thread.

Step 206 may be performed by any number of different techniques, possibly in combination, including but not limited to the use of threads to write to individual physical knowledge stores. For example, in some embodiments, other distribution methods may also include assignment based on triple patterns, assignment to stores based on some ontology, assignment based on which stores grant write permissions, and/or plugable custom algorithms written for a specific scenario.

In some embodiments, the method of FIG. 2 may include steps directed towards managing the client's access to the data records. For example, the client may attempt to find or query data records stored in the physical knowledge stores, but those data records may be temporarily stored in the buffer. Accordingly, teachings of certain embodiments recognize that the client's access to the distributed knowledge store may be blocked until the buffer is empty or all data records have been downloaded to the physical knowledge stores. After the buffer is empty, the client's regular access to the distributed knowledge store may be resumed.

In another embodiment, the data records stored in the buffer may be represented to the client as having already been downloaded to the physical knowledge stores. For example, data records stored in the buffer may be included in the client's read or query of the distributed knowledge store. Teachings of certain embodiments recognize that representing data records stored in the buffer to the client may improve the client's overall access to the distributed knowledge store. Once the data records have been downloaded from the buffer to the knowledge store, the data records may be represented as being stored in a physical data store.

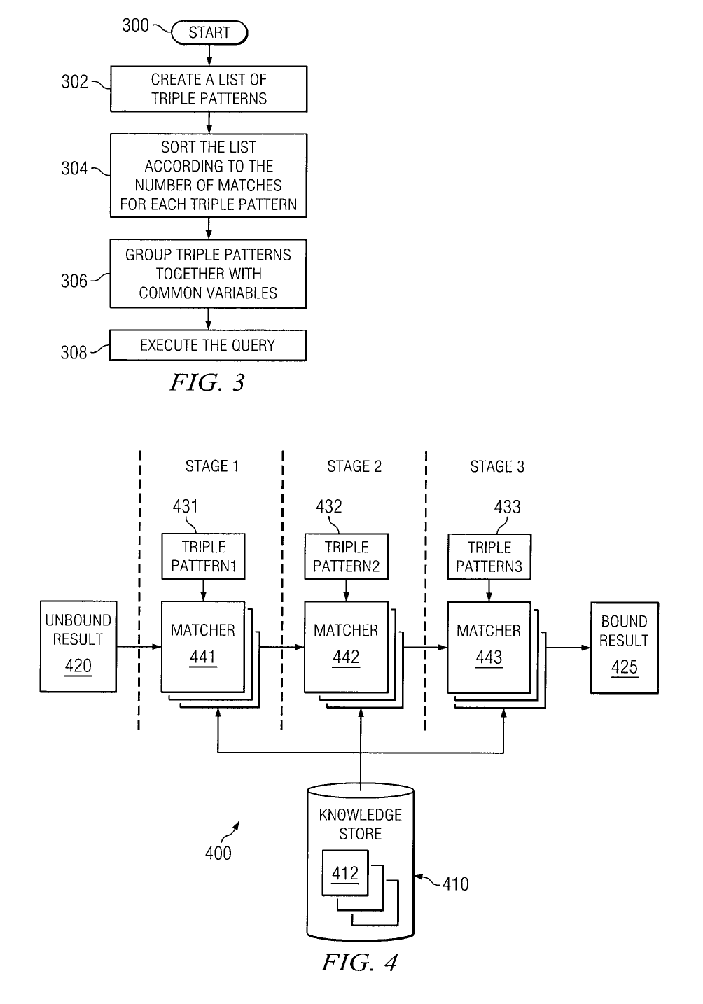

FIG. 3 presents one embodiment of a method for reading or querying from a distributed knowledge storage system. The method of FIG. 3 may incorporate one or more components of the distributed knowledge storage system of FIG. 1.

The method of FIG. 3 starts at step 300. At step 302, a list of triple patterns is created. The list of triple patterns may represent a query of data records. One example of the data records of step 202 may be the data records 112 from FIG. 1. In the embodiment presented in FIG. 3, the data records may represent RDF expressions.

The triple patterns may include at least one variable. In a query, the triple pattern matches an RDF expression when the terms of the RDF triple may be substituted for the variables of the triple pattern. Thus, embodiments of the triple patterns may have zero or more matches to RDF expressions located in a knowledge store. One example of a knowledge store of step 302 may be the knowledge stores 110 from FIG. 1. In some embodiments, the knowledge stores of step 302 may be organized into a distributed knowledge store. In one embodiment, the distributed knowledge store may be represented as a graph, and the physical knowledge stores may be represented as subgraphs of the graph.

At step 304, the list of triple patterns is sorted. For example, in one embodiment, the triple patterns are sorted according to the number of matches for each triple pattern. However, teachings of certain embodiments recognize that any mechanism for optimizing the sort order may be used.

In some embodiments, the triple patterns may be sorted in ascending order. Teachings of certain embodiments recognize that pushing triple patterns with the most specificity toward the beginning of the execution order may increase the query's speed and efficiency. For example, if a query may include three triple patterns, labeled as triple pattern A, triple pattern B, and triple pattern C. Triple patterns A, B, and C may have 1000, 5000, and 200 matches respectively. Thus, at step 302, the list of triple patterns may be sorted in ascending order: triple pattern C, then A, then B.

In one embodiment, step 304 may be executed using a count command. One example of a count command may include:

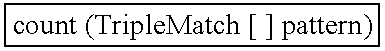

Teachings of certain embodiments recognize that a count command may optimize the execution of the triple patterns. For example, the count command may retrieve the number of triple pattern matches without retrieving the matches themselves, reducing the resources needed for sorting the list of triple patterns.

At step 306, the triple patterns may be grouped. For example, in one embodiment, the triple patterns are grouped with other triple patterns that include common variables. However, embodiments may include any number of optimizations to the grouping of triple patterns.

For example, in one embodiment, the triple patterns C, A, and B may have 10, 100, and 500 triple patterns respectively. If C and B share a common variable, the list of triple patterns may be modified such that C and B are together. Thus, after step 306, the list of triple patterns may read as C, B, and A. Teachings of certain embodiments recognize that minimizing the number of new variables introduced by each pattern may minimize the number of intermediate results.

At step 308, the query is executed. In one embodiment, step 308 may be executed using a find command. One example of a find command may include:

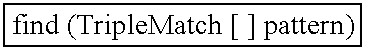

FIG. 4 presents one example of a query execution mechanism 400 that may be incorporated into step 308. The query execution mechanism 400 features a knowledge store 410, data records 412, an unbound result 420, a bound result 425, a collection of triple patterns 431, 432, and 433, and corresponding matchers 441, 442, and 443.

One example of the physical knowledge store 410 may be the knowledge store 110 from FIG. 1. One example of the data records 412 may be the data records 112 from FIG. 1. In the embodiment presented in FIG. 4, the data records may represent RDF expressions. The unbound result 420 and the bound result 425 may represent states before and after the query is executed.

In the embodiment presented in FIG. 4, the query is separated into three stages. Other embodiments may include greater or fewer stages. Each state corresponds to a triple pattern and a matcher. In FIG. 4, stage 1 corresponds to the triple pattern 431 and the matcher 441; stage 2 corresponds to the triple pattern 432 and the matcher 442; and stage 3 corresponds to the triple pattern 433 and the matcher 443.

The matchers 441, 442, and 443 may represent any mechanism for matching the triple pattern to the data records 412 stored in the knowledge store 410. For example, in one embodiment, operations of the matcher 441 may include identifying the triple pattern to be executed (in this example, triple pattern 431). The matcher 441 may then send the triple pattern 431 to the knowledge store 410, translate the triple pattern 431 into a format executable against the knowledge store 410, retrieve a set of triple pattern matches, and filter the match results according to any filters specified in the query. Those triple pattern matches may then forwarded to the matcher 442.

In another embodiment, the matcher 441 may execute the first stage of the query and retrieve a first set of triple pattern matches. The first set of triple pattern matches may then be bound to the second triple pattern through the matcher 442. For example, a knowledge store includes 10,000,000 data records 412 that match pattern 432 before binding, but the first set of triple pattern matches may include only 200 matches. The first set of triple pattern matches may be bound such that the matcher 442 does not waste resources by searching and returning all 10,000,000 data records 412. Teachings of certain embodiments recognize that binding matches to subsequent matcher operations may improve query performance.

In some embodiments, the matchers 441, 442, and 443 may be multi-threaded. For example, the matchers 441, 442, and 443 may include multiple threads connected to the knowledge store 410. In one example embodiment, steps of the matcher may be broken down into separate threads. Thus, if a matcher executes five steps, the matcher may increase efficiency by using five threads. In another embodiment, triple pattern matchers received from a previous stage may be separated into smaller groups. Each thread may then execute matches based the next triple pattern and on the small group of matches received from the previous matcher. In other words, the matchers may split the query into smaller chunks and execute the query in parallel. Embodiments may split the query into chunks based on steps, triple pattern matches, or any other mechanism for creating parallel queries. In some embodiments, the matchers 441, 442, and 443 may push operations to a thread in a common thread pool, which may parse and split operations into parallel queries.

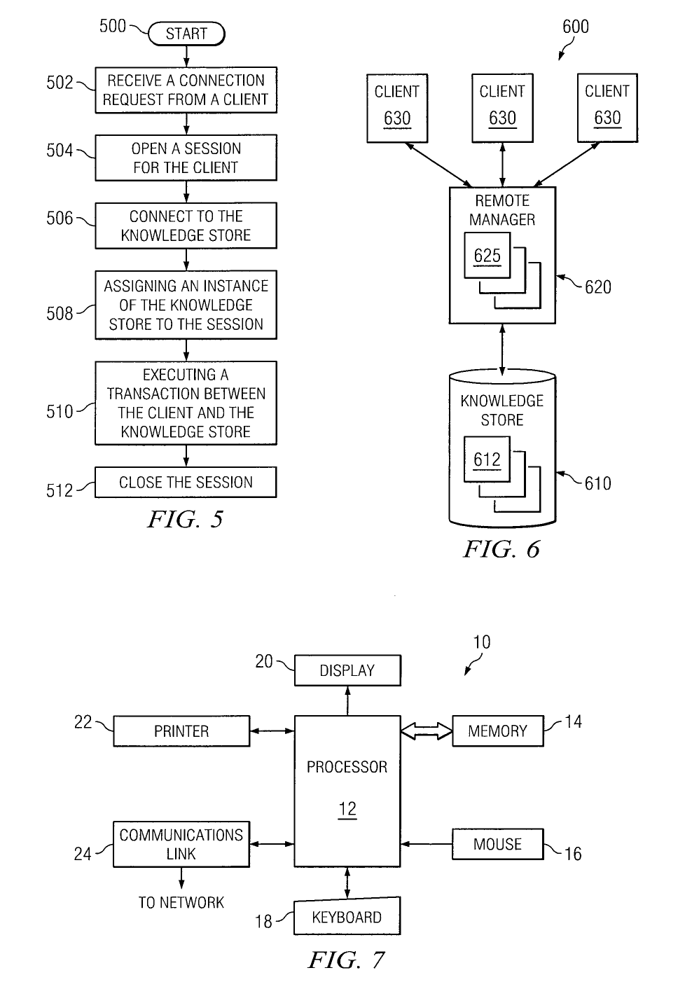

FIG. 5 presents one embodiment of a method for connecting multiple clients to a remote knowledge store. The method of FIG. 5 may incorporate one or more components of the knowledge storage system 600 of FIG. 6. FIG. 6 features a knowledge store 610, data records 612, a remote manager 620, and clients 630.

One example of the knowledge store 610 may be the knowledge store 110 from FIG. 1. Another example of the knowledge store 610 may be a distributed knowledge store, including multiple physical knowledge stores such as physical knowledge store 110. One example of the data records 612 may be the data records 112 from FIG. 1. One example of the clients 630 may be the client 130 from FIG. 1.

In some embodiments, the clients 630 may be connected to the remote manager 620 and/or the knowledge store 610 over a remote connection. Examples of a remote connection may a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding.

One example of the remote manager 620 may be the manager 120 from FIG. 1. The remote manager 620 may manage interactions between the knowledge stores 610 and the client 630. For example, in one embodiment, the remote manager 620 may be responsible for executing one or more of the steps presented in FIG. 5.

The method of FIG. 5 starts at step 500. At step 502, connection requests are received from a client. For example, in one embodiment, the remote manager 620 may receive the connection request from the client 630.

At step 504, a session is opened for the client. For example, in one embodiment, the remote manager 620 may open a session 625 for the client 630. In some embodiments, the session may be assigned a unique session identification marker. This session identification marker may enable the remote manager 620 to identify the session 625 and the connected client 630.

At step 506, the knowledge store is connected. For example, in one embodiment, the remote manager 620 may connect to the knowledge store 610. In one embodiment, the knowledge store is identified according to a uniform resource locator (URL) address.

At step 508, an instance of the knowledge store is assigned to the session. For example, in one embodiment, the remote manager 620 may assign an instance of the knowledge store 610 to the session 625. An instance may represent a connection to the knowledge store. For example, the instance may represent a graph object connected to an actual graph, located at the knowledge store. In one embodiment, an instance may be created on a per-transaction basis. In some embodiments, the instances may be stored in a pool of connections to the knowledge store. For example, in one embodiment, the remote manager 620 may manage the pool of connections, select the instances from the pool of connections, and attach the instances to the sessions 625.

At step 510, a transaction is executed between the client and the knowledge store. For example, in one embodiment, the remote manager 620 may execute the transaction between the client 630 and the knowledge store 610. Examples of the transaction may include a write transaction, a query transaction, or a transaction encompassing a combination of one or more read and write operations. These examples may include the write transaction presented in FIG. 2 or the query transaction presented in FIG. 3.

In some embodiments, the transaction may be invoked at the knowledge store and the remote manager without passing intermediate results to the client. For example, if the transaction is a query including multiple triple patterns, the knowledge store and the remote manager may not pass the matches for each triple pattern back to the client. Teachings of certain embodiments recognize that executing transactions near the knowledge store or the remote manager may reduce communication congestion between the components of the knowledge storage system 600.

At step 512, the session is closed. Embodiments may invoke different mechanisms for closing the session. For example, in one embodiment, the session may be closed after the transaction of step 510 is complete. In another embodiment, the transaction may be closed after a time-out period has elapsed. In yet another embodiment, the session may be closed in response to a request to close the session, such as a request from the client or other component.

Embodiments may include any suitable mechanism for authenticating clients for connection to a knowledge store and/or any other component. As one example, some embodiments may include mechanisms for authenticating the clients 630 for connection to the remote manager 620 and/or the knowledge store 610.

FIG. 7 presents an embodiment of a general purpose computer 10 operable to perform one or more operations of various embodiments of the invention. The general purpose computer 10 may generally be adapted to execute any of the well-known OS2, UNIX, Mac-OS, Linux, and Windows Operating Systems or other operating systems. The general purpose computer 10 in this embodiment comprises a processor 12, a memory 14, a mouse 16, a keyboard 18, and input/output devices such as a display 20, a printer 22, and a communications link 24. In other embodiments, the general purpose computer 10 may include more, less, or other component parts.

Several embodiments may include logic contained within a medium. Logic may include hardware, software, and/or other logic. Logic may be encoded in one or more tangible media and may perform operations when executed by a computer. Certain logic, such as the processor 12, may manage the operation of the general purpose computer 10. Examples of the processor 12 include one or more microprocessors, one or more applications, and/or other logic. Certain logic may include a computer program, software, computer executable instructions, and/or instructions capable being executed by the general purpose computer 10. In particular embodiments, the operations of the embodiments may be performed by one or more computer readable media storing, embodied with, and/or encoded with a computer program and/or having a stored and/or an encoded computer program. The logic may also be embedded within any other suitable medium without departing from the scope of the invention.

The logic may be stored on a medium such as the memory 14. The memory 14 may comprise one or more tangible, computer-readable, and/or computer-executable storage medium. Examples of the memory 14 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

The communications link 24 may be connected to a computer network or a variety of other communicative platforms including, but not limited to, a public or private data network; a local area network (LAN); a metropolitan area network (MAN); a wide area network (WAN) ; a wireline or wireless network; a local, regional, or global communication network; an optical network; a satellite network; an enterprise intranet; other suitable communication links; or any combination of the preceding.

Although the presented embodiment provides one embodiment of a computer that may be used with other embodiments of the invention, such other embodiments may additionally utilize computers other than general purpose computers as well as general purpose computers without conventional operating systems. Additionally, embodiments of the invention may also employ multiple general purpose computers 10 or other computers networked together in a computer network. For example, multiple general purpose computers 10 or other computers may be networked through the Internet and/or in a client server network. Embodiments of the invention may also be used with a combination of separate computer networks each linked together by a private or a public network.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been presented and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A method for writing to a distributed knowledge store, comprising:
receiving a plurality of Resource Description Framework (RDF) expressions;
identifying a distributed knowledge store, the distributed knowledge store comprising a plurality of physical knowledge stores; and
writing the plurality of RDF expressions to the distributed knowledge store by:
storing the plurality of RDF expressions in a buffer; and
receiving a plurality of threads from the plurality of physical knowledge stores, the plurality of threads responsible for downloading the plurality of RDF expressions to the plurality of physical knowledge stores.

2. The method of claim 1, wherein:
each physical knowledge store is represented by a write potential; and
the size of the buffer represents the total of the write potentials for the plurality of physical knowledge stores.

3. The method of claim 1, wherein:
the buffer stores the plurality of RDF expressions until a minimum number of RDF expressions is accumulated in the buffer; and
the plurality of threads downloads the plurality of RDF expressions after the minimum number of RDF expressions is accumulated in the buffer.

4. The method of claim 1, wherein the plurality of threads and the plurality of physical knowledge stores maintain a one-to-one correspondence.

5. The method of claim 1, wherein the RDF expression is an RDF triple.

6. The method of claim 1, further comprising:
blocking outside access by a client to the distributed knowledge store until the buffer is empty or all RDF expressions are downloaded to the plurality of physical knowledge stores.

7. The method of claim 1, further comprising:
representing the plurality of RDF expressions stored in the buffer to a client as having already been downloaded to the plurality of physical knowledge stores.

8. A method for querying from a distributed knowledge store, comprising:
creating a list of a plurality of triple patterns, each of the plurality of triple patterns comprising at least one variable, each of the plurality of triple patterns being associated with zero or more matches, the matches representing Resource Description Framework (RDF) expressions stored in a knowledge store;
sorting the list of triple patterns according to the number of matches for each triple pattern; and
grouping together triple patterns with common variables within the list of triple patterns.

9. The method of claim 8, wherein sorting the list of triple patterns according to the number of matches for each triple pattern comprises sorting the list of triple patterns in ascending order.

10. The method of claim 8, wherein the sorting the list of triple patterns according to the number of matches for each triple pattern comprises:
executing a count command on each triple pattern; and
sorting the triple patterns according to the results of the count command.

11. The method of claim 8, further comprising executing a query according to a query execution order, the query comprising a plurality of query stages, each stage corresponding to a triple pattern, the query execution order being defined by the list of triple patterns comprises.

12. The method of claim 11, wherein the query comprises a first stage and a second stage, the first stage corresponding to a first triple pattern, the second stage corresponding to a second triple pattern, the method further comprising:
executing the first stage of the query, the first stage creating a first set of triple matches corresponding to the first triple pattern; and
binding the first set of triple matches to the second triple pattern.

13. The method of claim 11, wherein executing a query comprises executing a query stage, the executing a query stage comprising:
identifying a triple pattern to be executed against the knowledge store;
sending the triple pattern to be executed to the knowledge store;
translating the triple pattern to be executed into a format executable against a data layer within the knowledge store;
retrieving a set of triple pattern matches from the knowledge store; and
sending the set of triple pattern matches from the knowledge store to a next stage of the query.

14. The method of claim 11, wherein at least one of the stages invokes a multi-threaded connection to the knowledge store.

15. A method for connecting a plurality of clients to an Resource Description Framework (RDF) knowledge store, comprising:
receiving a plurality of connection requests from a plurality of clients;
opening a session for each of the plurality of clients;
connecting to an RDF knowledge store, the Resource Development Framework (RDF) knowledge store comprising a plurality of RDF expressions; and
assigning an instance of the RDF knowledge store to each of the plurality of sessions, the instance of the RDF knowledge store representing a connection to the RDF knowledge store.

16. The method of claim 15, wherein the opening a session for each of the plurality of clients comprises assigning the plurality of clients a unique session identification marker.

17. The method of claim 15, wherein the RDF knowledge store is a distributed knowledge store, the distributed knowledge store comprising a plurality of physical knowledge stores.

18. The method of claim 15, the assigning an instance of the RDF knowledge store to each of the plurality of sessions comprises selecting the instance of the RDF knowledge store from a pool of connections to the RDF knowledge store.

19. The method of claim 15, further comprising:
facilitating a transaction between each of the plurality of clients and the RDF knowledge store; and
closing each session after the transaction is complete.

20. The method of claim 19, wherein the facilitating a transaction between each of the plurality of clients and the RDF knowledge store comprises:
receiving a transaction request from the client;
executing the transaction request at the knowledge store; and
passing only a set of results of the transaction request to the client.

21. The method of claim 15, further comprising closing the session after a time-out period has elapsed.

22. The method of claim 15, further comprising:
receiving a request to close the session; and
closing the session in response to the request to close the session.

23. The method of claim 15, wherein the receiving a plurality of connection requests from a plurality of clients comprises receiving a plurality of connection requests from a plurality of clients over a remote connection.

24. The method of claim 15, wherein the RDF knowledge stores is identified by a uniform resource locator (URL) address.

25. A computer-readable medium having computer-executable instructions, when executed by a computer configured to:
receive a plurality of RDF expressions;
identify a distributed knowledge store, the distributed knowledge store comprising a plurality of physical knowledge stores; and
write the plurality of Resource Description Framework (RDF) expressions to the distributed knowledge store by:
storing the plurality of RDF expressions in a buffer; and
receiving a plurality of threads from the plurality of physical knowledge stores, the plurality of threads responsible for downloading the plurality of RDF expressions to the plurality of physical knowledge stores.

26. The computer-readable medium of claim 1, wherein:
each physical knowledge store is represented by a write potential; and
the size of the buffer represents the total of the write potentials for the plurality of physical knowledge stores.

27. The computer-readable medium of claim 1, wherein:
the buffer stores the plurality of RDF expressions until a minimum number of RDF expressions is accumulated in the buffer; and
the plurality of threads downloads the plurality of RDF expressions after the minimum number of RDF expressions is accumulated in the buffer.

28. The computer-readable medium of claim 1, wherein the plurality of threads and the plurality of physical knowledge stores maintain a one-to-one correspondence.

29. The computer-readable medium of claim 1, wherein the RDF expression is an RDF triple.

30. The computer-readable medium of claim 14, the instructions when executed further configured to:
block outside access by a client to the distributed knowledge store until the buffer is empty or all RDF expressions are downloaded to the plurality of physical knowledge stores.

31. The computer-readable medium of claim 14, the instructions when executed further configured to:
represent the plurality of RDF expressions stored in the buffer to a client as having already been downloaded to the plurality of physical knowledge stores.

32. A computer-readable medium having computer-executable instructions, when executed by a computer configured to:
creating a list of a plurality of triple patterns, each of the plurality of triple patterns comprising at least one variable, each of the plurality of triple patterns being associated with zero or more matches, the matches representing Resource Description Framework (RDF) expressions stored in a knowledge store;
sorting the list of triple patterns according to the number of matches for each triple pattern;
grouping together triple patterns with common variables within the list of triple patterns.

33. The computer-readable medium of claim 32, the instructions when executed further configured to sort the list of triple patterns according to the number of matches for each triple pattern by sorting the list of triple patterns in ascending order.

34. The computer-readable medium of claim 32, the instructions when executed further configured to sort the list of triple patterns according to the number of matches for each triple pattern by:
executing a count command on each triple pattern; and
sorting the triple patterns according to the results of the count command.

35. The computer-readable medium of claim 32, the instructions when executed further configured to:
execute a query according to a query execution order, the query comprising a plurality of query stages, each stage corresponding to a triple pattern, the query execution order being defined by the list of triple patterns comprises.

36. The computer-readable medium of claim 35, wherein the query comprises a first stage and a second stage, the first stage corresponding to a first triple pattern, the second stage corresponding to a second triple pattern, the instructions when executed further configured to:
execute the first stage of the query, the first stage creating a first set of triple matches corresponding to the first triple pattern; and
bind the first set of triple matches to the second triple pattern.

37. The computer-readable medium of claim 35, wherein executing a query comprises executing a query stage, the executing a query stage comprising:
identifying a triple pattern to be executed against the knowledge store;
sending the triple pattern to be executed to the knowledge store;
translating the triple pattern to be executed into a format executable against a data layer within the knowledge store;
retrieving a set of triple pattern matches from the knowledge store; and
sending the set of triple pattern matches from the knowledge store to a next stage of the query.

38. The computer-readable medium of claim 35, herein at least one of the stages invokes a multi-threaded connection to the knowledge store.

39. A computer-readable medium having computer-executable instructions, when executed by a computer configured to:
receive a plurality of connection requests from a plurality of clients;
open a session for each of the plurality of clients;
connect to an Resource Description Framework (RDF) knowledge store, the RDF knowledge store comprising a plurality of RDF expressions; and
assign an instance of the RDF knowledge store to each of the plurality of sessions, the instance of the RDF knowledge store representing a connection to the RDF knowledge store.

40. The computer-readable medium of claim 39, the instructions when executed further configured to open a session for each of the plurality of clients by assigning the plurality of clients a unique session identification marker.

41. The computer-readable medium of claim 39, wherein the RDF knowledge store is a distributed knowledge store, the distributed knowledge store comprising a plurality of physical knowledge stores.

42. The computer-readable medium of claim 39, the instructions when executed further configured to assign an instance of the RDF knowledge store to each of the plurality of sessions by selecting the instance of the RDF knowledge store from a pool of connections to the RDF knowledge store.

43. The computer-readable medium of claim 39, the instructions when executed further configured to:
facilitate a transaction between each of the plurality of clients and the RDF knowledge store; and
close each session after the transaction is complete.

44. The computer-readable medium of claim 43, the instructions when executed further configured to facilitate a transaction between each of the plurality of clients and the RDF knowledge store by:
receiving a transaction request from the client;
executing the transaction request at the knowledge store; and
passing only a set of results of the transaction request to the client.

45. The computer-readable medium of claim 39, the instructions when executed further configured to close the session after a time-out period has elapsed.

46. The computer-readable medium of claim 39, the instructions when executed further configured to:
receive a request to close the session; and
close the session in response to the request to close the session.

47. The computer-readable medium of claim 39, the instructions when executed further configured to receive a plurality of connection requests from a plurality of clients by receiving a plurality of connection requests from a plurality of clients over a remote connection.

48. The computer-readable medium of claim 39, wherein the RDF knowledge stores is identified by a uniform resource locator (URL) address.
